(19) United States
(12) Patent Application Publication
(10) Pub. No.: US 2010/0221018 A1
(43) Pub. Date: Sep. 2, 2010

(54) Polarization mode dispersion suppressing method and polarization mode dispersion suppressing apparatus

(75) Inventor: Yoshihiro Kanda, Tokyo (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/659,101

(22) Filed: Feb. 25, 2010

(30) Foreign Application Priority Data
Feb. 27, 2009 (JP) 2009-046374

(51) Int. Cl. H04B 10/30

(52) U.S. Cl. 398/152

(57) ABSTRACT

A polarization mode dispersion (PMD) suppressing apparatus wherein a first polarization controller adjusts a polarization of an input signal, thereby generating a first polarization adjusted signal; a variable DGD compensator gives a DGD to the first polarization adjusted signal, thereby generating a first PMD compensated signal; a second polarization controller adjusts a polarization of the first PMD compensated signal, thereby generating a second polarization adjusted signal; a polarization beam splitter produces a higher-order PMD suppressed signal forming one of two orthogonal components of the second polarization adjusted signal and a monitor signal forming the other component; an intensity detector generates an optical carrier intensity signal reflecting the intensity of an optical carrier wavelength component; and a control signal generator controls the first polarization controller, etc., based on the optical carrier intensity signal such that the optical carrier wavelength component intensity becomes minimal.

### BACKGROUND OF THE INVENTION

1. Field of the Invention

The present invention relates to a PMD suppressing method and PMD suppressing apparatus for compensating distortion of the time waveforms of optical pulses occurring due to polarization mode dispersion (PMD) in an optical fiber transmission line in optical transmission systems.

2. Description of the Related Art

In high speed optical transmission at a communication speed of greater than 10 Gbits/s, one of the major factors that limit the distance over which transmission is feasible without a relay or repeater station in between is the distortion of the time waveforms of optical pulses forming an optical pulse signal which is caused by the optical pulses propagating through an optical fiber transmission line. One of the causes of this distortion of the time waveforms of optical pulses is PMD. This PMD occurs for the following reason.

Because of a bending stress applied to an optical fiber transmission line in the optical fiber production process, the influence of temperature variation, or the like, the cross-sectional shape of the core of the optical fiber slightly deviates from a true circle, resulting in the occurrence of birefringence in the optical fiber. The birefringence causes the phenomenon that the propagation phase velocity of an optical pulse propagating through the optical fiber depends on the oscillation direction of the optical electric field. The oscillation direction for which the phase velocity of the optical pulse is greater is referred to as a “fast axis”, and the oscillation direction for which it is smaller is referred to as a “slow axis”.

When an optical pulse propagates through an optical fiber, a transmission time difference between orthogonal polarization components of the optical pulse, i.e., a differential group delay (DGD) occurs due to the birefringence. This phenomenon is PMD.

The magnitude level of the PMD that occurs in an optical fiber transmission line is indicated by a PMD coefficient (unit: ps km^{1/2}). According to a Recommendation of the International Telecommunication Union Telecommunication Standardization Sector (ITU-T), the PMD coefficient of standard single mode fibers is desirably 0.2 ps/km^{1/2} or less. However, the PMD coefficient of optical fibers constituting optical fiber transmission lines in use varies depending on the period when the optical fiber network was laid.

When the inverse of the value of the DGD of an optical fiber transmission line becomes larger than the spectrum band width of optical pulse signals, the influence of higher-order PMD cannot be neglected. The higher-order PMD is known as the phenomenon that in addition to change in the Principal State of Polarization (PSP) expressed as the rotation of the terminal point of a PMD vector on the Poincare sphere according to the frequency (or wavelength) of the optical carrier wave of optical pulse signals, the difference in propagation velocity between an optical electric field component parallel to the fast axis and an optical electric field component parallel to the slow axis varies depending on the frequency (or wavelength) of the optical carrier wave. This phenomenon is referred to as polarization dependent chromatic dispersion (PCD).

The higher-order PMD can be described as follows. When an optical pulse propagates through an optical fiber transmission line, the shorter wavelength component and the longer wavelength component of the spectrum of the optical pulse differ in the directions of the fast axis and the slow axis as well. That is, letting the z-axis represent the wave-guiding direction in the optical fiber transmission line, the z-axis dependency of the directions of the fast axis and the slow axis varies per wavelength component, and also the value of the DGD varies per wavelength component. Hence the time waveform of the optical pulse is deformed complicatedly. As such, the PMD which occurs due to variation in the directions of the fast axis and the slow axis and variation in the value of the DGD depending on the wavelength is the higher-order PMD.

As far as first-order PMD is concerned, there is no such wavelength dependency, and as to second-order PMD, it is known that this wavelength dependency varies at a certain rate.

Because the PMD varies with temperature change of the optical fiber transmission line and with external stress applied to the optical fiber from the outside, the PMD varies with time. Accordingly, as PMD suppressing methods for compensating the distortion of the time waveform of the optical pulse due to the PMD, methods which adaptively perform optical suppression or electrical suppression are known.

With the electrical suppression method, it is difficult to perform PMD suppression on optical pulse signals whose transmission speed exceeds 40 Gbits/s due to the upper limit of operation speed of electronic devices. Accordingly, an optically suppressing method is needed. PMD suppressing apparatus which implement the optically suppressing method of the PMD are being widely researched since also having an excellent advantage of not being dependent on the modulation format and transmission bit rate of optical pulse signals.

As a signal necessary to achieve an adaptive suppression operation, for example, the degree of polarization (DOP) representing polarization uniformity in the optical pulse signal spectrum can be used, and a method is known which controls the DOP to increase. The DOP is calculated by measuring Stokes parameters using a polarimeter.

There is disclosed a method wherein as means for suppressing PMD including the higher-order component, a polarization controller and a polarization beam splitter (PBS) are arranged in order at the stage subsequent to a first-order PMD compensation unit to remove the depolarization component. Refer to, for example, Julien Poirrier, Fred Buchali, and Henning Bulow, “Higher Order PMD Canceller”, OFC2002, WI4 (hereinafter, referred to as Non-patent document 1), FIG. 1, and K. Ikeda, “Simple PMD Compensator with Higher Order PMD Mitigation”, OFC2003, MF90 (hereinafter, referred to as Non-patent document 2), FIG. 1(a).

According to the method disclosed in Non-patent document 1, the first-order PMD compensation unit is controlled such that the DOP becomes maximal, and in a higher-order PMD suppressing unit, the polarization controller is controlled such that the intensity of the output signal at one side of the PBS becomes minimal.

In contrast, according to the method disclosed in Non-patent document 2, in a higher-order PMD suppressing unit of the same configuration as the one disclosed in Non-patent document 1 cited above, both the first-order PMD compensation unit and the higher-order PMD suppressing unit, monitoring the intensity of the output signal at one side of the PBS, controls this output signal intensity to become minimal. By this means, the method disclosed in Non-patent document 2 can be implemented by an apparatus configured without a DOP monitor. That is, the method disclosed in Non-patent document 2 uses the fact that the state where the intensity of the output signal at one side of the PBS is minimal through controlling parameters of the entire compensation apparatus is equal to the state where the DOP in the first-order PMD compensation unit is controlled to be maximal.

Also refer to Magnus Karlsson, Chongjin Xie, Henrik Sunnerud, and Peter A. Andrekson, “Higher Order Polarization Mode Dispersion Compensator with Three Degrees of Freedom”, OFC2001, MOI-1 (hereinafter, referred to as on-patent document 3).

### SUMMARY OF THE INVENTION

In a conventional higher-order PMD suppressing apparatus, first, as disclosed in Non-patent document 1 cited above, in a functional section compensating for the first-order PMD (the first-order PMD compensation unit), a condition represented by a PMD vector equal in magnitude and opposite in direction to a PMD vector at the optical carrier wavelength is created, and by adding both the vectors, the first-order PMD is compensated for. In addition, the higher-order PMD component is removed with use of the PBS to obtain an optimum control state. In the description below, compensating for the first-order PMD by creating a condition where a PMD vector equal in magnitude and opposite in direction to the PMD vector is realized and adding both the vectors, may be referred to as “equalizing” the PMD vector.

In the conventional higher-order PMD suppressing apparatus, in the first-order PMD compensation unit, the DOP is used as a monitor signal that is a reference for compensating for the first-order PMD, whereas a signal output from the PBS is used as a monitor signal that is a reference for suppressing higher-order PMD in the higher-order PMD suppressing unit. It is known that the state where the DOP in the first-order PMD compensation unit is controlled to be maximal is, also for optical pulses of an optical pulse signal affected by the higher-order PMD, a state where the spread on a time axis of the optical pulse (distortion amount of the time waveform of the optical pulse) is minimal (refer to, e.g., Non-patent document 3).

In general, the first-order PMD compensation unit comprises a polarization controller formed of a combination of a quarter-wave plate and a half-wave plate, and a variable DGD compensator, and has a first-order PMD compensation capability having the degrees of rotational freedom of the quarter-wave plate and the half-wave plate and the degree of DGD adjustment freedom of the variable DGD compensator for a total of three degrees of freedom. Controlling the DOP to be maximal in the first-order PMD compensation unit having the configuration as mentioned above is equivalent to averaging the PSP per unit wavelength over the spectrum of an optical pulse to compensate, and hence also as to optical pulses of an optical pulse signal affected by the higher-order PMD as mentioned above, their distortion amount becomes minimal.

However, the control state where the PMD is compensated for by averaging the PSP having wavelength dependency as mentioned above is different from a state where a PMD vector at the optical carrier wavelength is equalized. The conventional higher-order PMD suppressing apparatus described above is configured to remove the unpolarized component from the signal output from the first-order PMD compensation unit with use of the PBS. Hence, the effect of suppressing the PMD is considered to be smaller than in the state where the PSP at the optical carrier wavelength from among the wavelength components of an input signal is compensated in the first-order PMD compensation unit.

The conventional PMD suppressing apparatus does not comprise means for monitoring whether the PSP at the optical carrier wavelength is compensated, which state is an optimum state for achieving an effective higher-order PMD suppression as described above, and thus it is difficult to obtain a higher-order PMD suppression effect effectively.

An object of the present invention is to provide a PMD suppressing method which can set the first-order PMD compensation unit to be in a control state of compensating for the DGD at the optical carrier wavelength and set the higher-order PMD suppressing unit to be in a control state of effectively suppressing the higher-order PMD, and a PMD suppressing apparatus for implementing this method.

The inventor of this application focused attention on the phenomenon of variation in the PSP expressed as the rotation of the PMD eigen-axis where the terminal point of the PMD vector rotates on the Poincare sphere. And the inventor realized that by taking out the optical carrier wavelength component and using its intensity information as a control signal, the first-order PMD compensation at the optical carrier wavelength in the first-order PMD compensation unit and the removal of the unpolarized component in the higher-order PMD suppressing unit are implemented, thus producing an excellent higher-order PMD suppression effect.

That is, the inventor became convinced that taking out the optical carrier wavelength component as a monitor signal by spectroscopy of one of orthogonal polarization components of the output signal output from the PMD suppressing apparatus to use the intensity information of the optical carrier wavelength component as a control signal for PMD suppression, the first-order PMD compensation and the suppression of the higher-order PMD can be effectively performed, and ascertained by experiment that with this method, the higher-order PMD can be more effectively suppressed than with the conventional method.

According to the summary of the invention based on the above-described concept, a PMD suppressing apparatus and a PMD suppressing method described below are provided.

According to a first aspect of the invention, the PMD suppressing method is configured to include a first polarization controlling step, a DGD compensation step, a second polarization controlling step, a polarization separating step, an optical carrier wavelength component intensity detecting step, and a control step.

The first polarization controlling step is a step of, for an input signal as a PMD suppression-subject signal (i.e., a signal to be PMD-suppressed), adjusting a polarization state of the input signal, thereby generating a first polarization plane adjusted signal.

The DGD compensation step is a step of giving a DGD to one polarization mode component of an orthogonal eigen-polarization mode of the first polarization plane adjusted signal, thereby generating a first PMD compensated signal.

The effect of first-order PMD compensation is obtained by the above first polarization controlling step and DGD compensation step.

The second polarization controlling step is a step of adjusting a polarization state of the first PMD compensated signal, thereby generating a second polarization plane adjusted signal.

The polarization separating step is a step of producing and outputting a higher-order PMD suppressed signal forming one of two orthogonal components of the second polarization plane adjusted signal and a monitor signal forming the other component.

The effect of higher-order PMD suppression is obtained by the above second polarization controlling step and polarization separating step.

The optical carrier wavelength component intensity detecting step is a step of measuring intensity of an optical carrier wavelength component of the input signal in the monitor signal and generating an optical carrier intensity signal reflecting the intensity of the optical carrier wavelength component.

The control step is a step of adjusting the polarization state of the PMD suppression-subject signal based on the optical carrier intensity signal such that the intensity of the optical carrier wavelength component becomes minimal and giving a DGD to the one polarization mode component of the orthogonal eigen-polarization mode of the first polarization plane adjusted signal and adjusting the polarization state of the first PMD compensated signal.

According to a second aspect of the invention, the PMD suppressing apparatus implementing the PMD suppressing method according to the first aspect of the invention comprises a first polarization controller, a variable DGD compensator, a second polarization controller, a polarization beam splitter, an optical carrier wavelength component intensity detector, and a control signal generator. The first polarization controller and the variable DGD compensator form a first-order PMD compensation unit, and the second polarization controller and the polarization beam splitter form a higher-order PMD suppressing unit.

The first polarization controller, for an input signal as a PMD suppression-subject signal, adjusts a polarization state of the input signal, thereby generating a first polarization plane adjusted signal.

The variable DGD compensator, having the first polarization plane adjusted signal inputted thereto, gives a DGD to one polarization mode component of an orthogonal eigen-polarization mode of the first polarization plane adjusted signal, thereby generating a first PMD compensated signal.

The second polarization controller, having the first PMD compensated signal inputted thereto, adjusts a polarization state of the first PMD compensated signal, thereby generating a second polarization plane adjusted signal.

The polarization beam splitter, having the second polarization plane adjusted signal inputted thereto, produces and outputs a higher-order PMD suppressed signal forming one of two orthogonal components of the second polarization plane adjusted signal and a monitor signal forming the other component.

The optical carrier wavelength component intensity detector, having the monitor signal inputted thereto, measures intensity of an optical carrier wavelength component of the input signal included in the monitor signal and generates an optical carrier intensity signal reflecting the intensity of the optical carrier wavelength component.

The control signal generator, having the optical carrier intensity signal inputted thereto, generates, based on the optical carrier intensity signal, first to third parameter signals for controlling respectively the first polarization controller, the variable DGD compensator, and the second polarization controller such that the intensity of the optical carrier wavelength component becomes minimal.

The higher-order PMD suppressed signal forming the one of two orthogonal components of the second polarization plane adjusted signal and output from the polarization beam splitter is a PMD suppressed signal output from the PMD suppressing apparatus of the invention.

The optical carrier wavelength component intensity detector preferably comprises a spectrum analyzer. Or, the optical carrier wavelength component intensity detector may comprise a band pass filter and a photodetector.

According to the PMD suppressing apparatus and the PMD suppressing method according to the first and second aspects of the invention, an input signal that is a PMD suppression-subject signal inputted to the first polarization controller, has its polarization state adjusted and is input to the variable DGD compensator, and in the variable DGD compensator, is given a DGD and input to the second polarization controller. The first polarization plane adjusted signal output from the variable DGD compensator, i.e. output from the first-order PMD compensation unit, is the first PMD compensated signal having the first-order PMD compensated for provisionally.

The first PMD compensated signal is input to the second polarization controller and has its polarization state adjusted and is output as the second polarization plane adjusted signal. The second polarization plane adjusted signal is input to the polarization beam splitter, and its two orthogonal polarization components are separated and output. A signal output from the polarization beam splitter, i.e. output from the higher-order PMD suppressing unit, is the higher-order PMD suppressed signal having the higher-order PMD suppressed provisionally.

If the higher-order PMD is effectively suppressed, the optical carrier wavelength component of the second polarization plane adjusted signal has a polarization state close to linear polarization. Thus, by taking out this linear polarization component using the polarization beam splitter as an analyzer, a signal having the higher-order PMD suppressed can be taken out.

If the polarization beam splitter is set such that the polarization direction of the transmitted beam passing through and output from the polarization beam splitter coincides with the linear polarization direction of this second polarization plane adjusted signal, the reflected beam reflected by and output from the polarization beam splitter is a beam having a polarization characteristic that is of a polarization direction orthogonal to that of the second polarization plane adjusted signal. The PMD suppressing apparatus according to the second aspect of the invention is configured to use the reflected beam reflected by and output from the polarization beam splitter as the monitor signal.

The reflected beam reflected by and output from the polarization beam splitter is input to the optical carrier wavelength component intensity detector, and the intensity of the optical carrier wavelength component included in the reflected beam is measured. When the intensity of the optical carrier wavelength component in the reflected beam becomes minimal, the intensity of the optical carrier wavelength component included in the transmitted beam passing through and output from the polarization beam splitter becomes maximal. When adjusted in this way, the higher-order PMD is suppressed most effectively.

In the optical carrier wavelength component intensity detector, the intensity of the optical carrier wavelength component in the monitor signal is measured, and the optical carrier intensity signal reflecting this intensity is output. Then, based on this signal, the control signal generator can control the first polarization controller, the variable DGD compensator, and the second polarization controller such that the intensity of the optical carrier wavelength component included in the monitor signal reflected by and output from the polarization beam splitter becomes minimal.

The first polarization plane controlling step, DGD compensation step, second polarization controlling step, polarization separating step, optical carrier wavelength component intensity detecting step, and control step of the PMD suppressing method according to the first aspect of the invention can be performed in the first polarization controller, the variable DGD compensator, the second polarization controller, the polarization beam splitter, the optical carrier wavelength component intensity detector, and the control signal generator, respectively.

The feature of the PMD suppressing method according to the first aspect of the invention is to observe the intensity of the optical carrier wavelength component of the monitor signal that is the reflected beam reflected by and output from the polarization beam splitter and to control the first polarization controller, the variable DGD compensator, and the second polarization controller such that this intensity becomes minimal.

The first PMD compensated signal having the first-order PMD compensated for provisionally that is output from the first-order PMD compensation unit in the state where this intensity is minimal with observing the intensity of the optical carrier wavelength component of the monitor signal, is a first PMD compensated signal determined in the PMD suppressing apparatus of the invention. Further, likewise, the higher-order PMD suppressed signal having the higher-order PMD suppressed provisionally that is output from the higher-order PMD suppressing unit is a higher-order PMD suppressed signal determined in the PMD suppressing apparatus of the invention.

In the conventional PMD suppressing apparatus, it is difficult to determine a state where the DGD at the optical carrier wavelength is compensated for in the first-order PMD compensation unit. Further, in the higher-order PMD suppressing unit configured with a polarizer placed at the subsequent stage, the effect of sufficient suppression of the higher-order PMD component cannot be obtained.

However, in the PMD suppressing apparatus according to the second aspect of the invention, by using the intensity of the optical carrier wavelength component of the monitor signal reflected by and output from the polarization beam splitter in PMD suppression control as described above, a control state where the DGD at the optical carrier wavelength is equalized is determined in the first-order PMD compensation unit, and the effect of high suppression of the higher-order PMD component is achieved in the higher-order PMD suppressing unit.

Moreover, an optical spectrum analyzer can be used to separate the optical carrier wavelength component of the monitor signal and measure its intensity. Or, the PMD suppressing apparatus may be configured to separate the optical carrier wavelength component of the monitor signal by an optical band pass filter and, by a photodiode, to convert it into an electric signal to measure its intensity.

### BRIEF DESCRIPTION OF THE DRAWINGS

FIG. 1 is a schematic block configuration diagram of a PMD suppressing apparatus according to an embodiment of the present invention;

FIG. 2 is a schematic block configuration diagram showing the configuration of a demonstration system for verifying the effect of higher-order PMD suppression by the PMD suppressing apparatus of the invention;

FIG. 3A shows a result of numerical computation of the time waveform of a CS-RZ signal output from a transmitter;

FIG. 3B shows a result of numerical computation of the time waveform of an input signal output from a higher-order PMD emulator;

FIG. 4 is for explaining the PMD given by the higher-order PMD emulator being higher-order PMD;

FIGS. 5A and 5B show the time waveforms of the output signals output from first-order PMD compensation units to be compared, FIG. 5A shows the time waveform of the first PMD compensated signal output from the first-order PMD compensation unit of the PMD suppressing apparatus according to the embodiment of the invention, and FIG. 5B shows the time waveform of the signal output from the first-order PMD compensation unit of a conventional PMD suppressing apparatus;

FIGS. 6A and 6B show the time waveforms of the output signals output from higher-order PMD suppressing units to be compared, FIG. 6A shows the time waveform of the second polarization plane adjusted signal output from a second polarization controller of the PMD suppressing apparatus according to the embodiment the invention, and FIG. 6B shows the time waveform of the signal output from the higher-order PMD suppressing unit of the conventional PMD suppressing apparatus;

FIGS. 7A and 7B show the time waveforms of the monitor signals output from higher-order PMD suppressing units to be compared, FIG. 7A shows the time waveform of the monitor signal output from the higher-order PMD suppressing unit of the PMD suppressing apparatus according to the embodiment of the invention; and FIG. 7B shows the time waveform of the monitor signal output from the higher-order PMD suppressing unit of the conventional PMD suppressing apparatus;

FIGS. 8A to 8C are for explaining results of further verification experiment of the effect of PMD suppression by the PMD suppressing apparatus according to the embodiment of the invention, FIG. 8A shows the time waveform of the CS-RZ signal that is the output signal of the transmitter observed at the position indicated by “s” in FIG. 2, FIG. 8B shows the time waveform of the input signal output from the higher-order PMD emulator observed at the position indicated by “p” in the figure, and FIG. 8C shows the time waveform of the first PMD compensated signal output from a variable DGD compensator of the PMD suppressing apparatus according to the embodiment of the invention observed at the position indicated by “q” in the figure;

FIGS. 9A and 9B are for explaining experiment results of verification of the difference in the effect of higher-order PMD suppression between the PMD suppressing apparatus according to the embodiment of the invention and the conventional PMD suppressing apparatus, FIG. 9A shows the time waveform of the output signal when the higher-order PMD is suppressed by the conventional higher-order PMD suppressing method, and FIG. 9B shows the time waveform of the output signal when the higher-order PMD is suppressed by the PMD suppressing method according to the embodiment of the invention;

FIG. 10 shows the wavelength spectra of signals in the same experiment: (α) the input signal generated by adding the higher-order PMD to the CS-RZ signal output from the transmitter, (β) the output signal having the higher-order PMD suppressed by the conventional higher-order PMD suppressing method, and (γ) the output signal having the higher-order PMD suppressed by the PMD suppressing method according to the embodiment of the invention; and

FIG. 11 shows an result of an experiment in the same experiment system for another embodiment of optical carrier intensity detecting means, showing the time waveform of the higher-order PMD suppressed signal obtained where the detector is configured with a combination of an optical band pass filter and a photodetector to obtain an optical carrier intensity signal.

### DETAILED DESCRIPTION OF THE INVENTION

The configuration of a PMD suppressing apparatus of an embodiment of the present invention, and numerical computation and experiment results verifying that the control state of equalizing the DGD at the optical carrier wavelength is determined in the first-order PMD compensation unit of the PMD suppressing apparatus and that the effect of high suppression of the higher-order PMD is achieved in the higher-order PMD suppressing unit will be described.

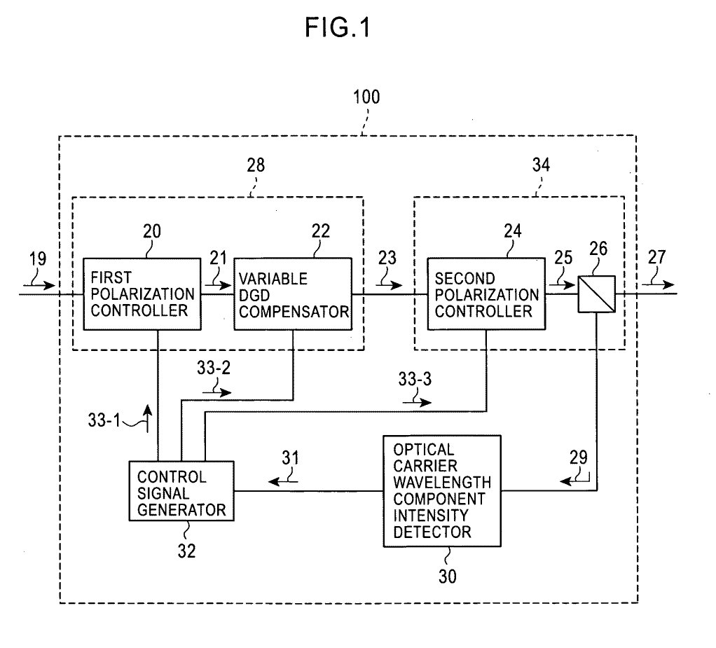

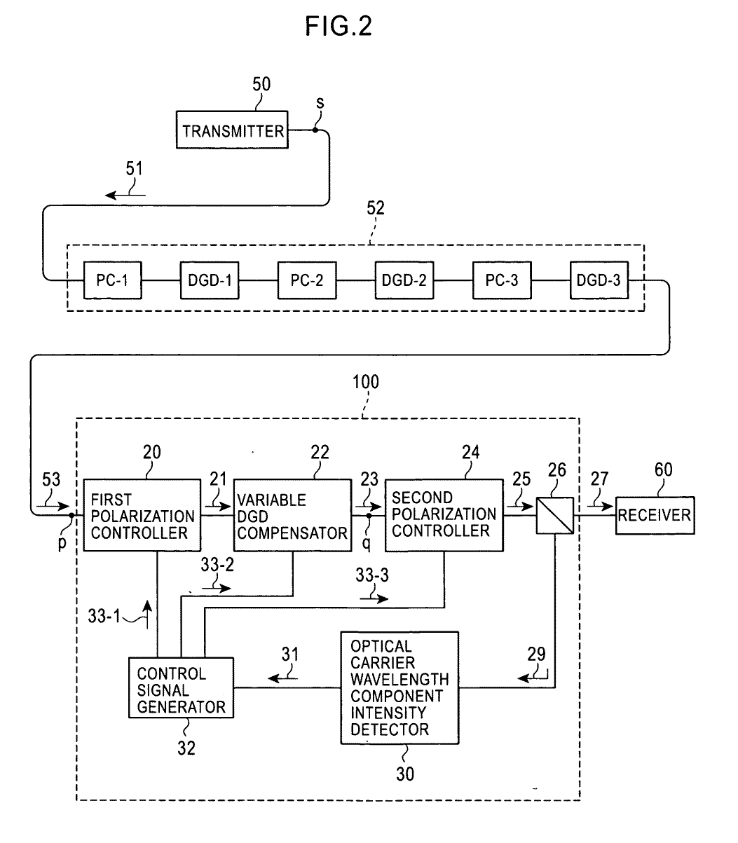

The embodiment of the present invention will be described with reference to FIG. 1. Note that FIG. 1 showing an example configuration of the PMD suppressing apparatus according to the invention, it is not intended to limit the invention to the illustrative example. With reference to FIGS. 2 to 11, experiment outline and results for verifying that with the PMD suppressing method of the invention the PMD can be more effectively suppressed than with the conventional method will be described. The same reference numerals are used to denote common constituents in FIGS. 1 and 2 with duplicate description thereof being omitted. Although in the description below, specific elements, operation conditions, etc., are referred to, these elements and operation conditions are a few of the preferred examples, and they are not limited to these at all.

### <PMD Suppressing Apparatus>

The configuration and operation of the PMD suppressing apparatus according to the embodiment of the present invention will be described with reference to FIG. 1. FIG. 1 is a schematic block configuration diagram of the PMD suppressing apparatus according to the embodiment of the invention. The optical signal paths are indicated by thick lines, and the electric signal paths are indicated by thin lines.

The PMD suppressing apparatus 100 according to the embodiment of the invention comprises a first-order PMD compensation unit 28, a higher-order PMD suppressing unit 34, an optical carrier wavelength component intensity detector 30, and a control signal generator 32. The first-order PMD compensation unit 28 comprises a first polarization controller 20 and a variable DGD compensator 22, and the higher-order PMD suppressing unit 34 comprises a second polarization controller 24 and a polarization beam splitter 26. The first-order PMD compensation unit 28 can be set to be in a control state of compensating for the DGD at the optical carrier wavelength, and the higher-order PMD suppressing unit 34 can be set to be in a control state of effectively suppressing the higher-order PMD.

The first polarization controller 20, for a PMD suppression-subject signal inputted as an input signal 19, adjusts the polarization state of the input signal 19 to generate a first polarization plane adjusted signal 21. Adjusting the polarization state of an input signal means making oscillation directions of orthogonal oscillating components of the input signal respectively match the fast axis and slow axis of the variable DGD compensator 22 used in a DGD compensation step at the subsequent stage.

The variable DGD compensator 22 has the first polarization plane adjusted signal 21 input thereto and gives the DGD to one polarization mode component of an orthogonal eigen-polarization mode of the first polarization plane adjusted signal 21 to generate a first PMD compensated signal 23.

In the PMD suppressing apparatus 100 of the invention, the first-order PMD compensation is implemented by the first polarization controller 20 and the variable DGD compensator 22. The first polarization controller 20 and a polarization controller used as the second polarization controller 24 described later can transform an input signal to an arbitrary polarization state and are constituted by a combination of a half-wave plate and a quarter-wave plate. As the polarization controller, a polarization controller formed of a fiber squeezer, a lithium niobate crystal, or the like can be used as needed.

The variable DGD compensator 22 can be realized using a birefringent medium. The compensator 22 is realized by combining, for example, a polarization maintaining fiber (PMF), a polarization beam splitter, and optical path length varying means.

The second polarization controller 24 has the first PMD compensated signal 23 input thereto and adjusts the polarization state of the first PMD compensated signal 23 to generate a second polarization plane adjusted signal 25.

The polarization beam splitter 26 has the second polarization plane adjusted signal 25 input thereto and generates and outputs a higher-order PMD suppressed signal 27 forming one of two orthogonal components of the second polarization plane adjusted signal 25, and a monitor signal 29 forming the other component.

The optical carrier wavelength component intensity detector 30 has the monitor signal 29 input thereto and measures the intensity of the optical carrier wavelength component of the input signal 19 and generates an optical carrier intensity signal 31 reflecting the intensity of the optical carrier wavelength component.

The control signal generator 32 has the optical carrier intensity signal 31 input thereto and, based on the optical carrier intensity signal 31, generates a first parameter signal 33-1, a second parameter signal 33-2, and a third parameter signal 33-3 to control respectively the first polarization controller 20, the variable DGD compensator 22, and the second polarization controller 24 such that the intensity of the optical carrier wavelength component becomes minimal.

The algorithm for controlling such that the intensity of the optical carrier wavelength component of the monitor signal 29 that is reflected by and output from the polarization beam splitter 26 becomes minimal uses a technique of comparing the intensity of the optical carrier wavelength component of the monitor signal 29 which is measured when the first polarization controller 20, the variable DGD compensator 22, and the second polarization controller 24 are each set to be in an arbitrary state and the intensity of the optical carrier wavelength component of the monitor signal after controlled by the first to third parameter signals and, based on that intensity difference, sequentially reducing the intensity of the optical carrier wavelength component of the monitor signal 29. As this algorithm to search for a minimum, a well-known PSO (Particle Swarm Optimization) algorithm, an algorithm based on a steepest-descent method, or the like can be used as needed.

The higher-order PMD suppressed signal 27 forming one of the two orthogonal components of the second polarization plane adjusted signal output from the polarization beam splitter 26 is a PMD suppressed signal output from the PMD suppressing apparatus 100 of the invention.

The optical carrier wavelength component intensity detector 30 preferably comprises a spectrum analyzer. In this case, the spectrum analyzer separates the optical carrier wavelength component from the monitor signal 29 and observes the intensity of the optical carrier wavelength component.

In contrast, if the optical carrier wavelength component intensity detector 30 is configured with a band pass filter and a photodetector, the band pass filter separates the optical carrier wavelength component from the monitor signal 29, and an optical signal of the optical carrier wavelength component output from the band pass filter is converted into an electric intensity signal, and output, by the photodetector. That is, by obtaining the electric intensity signal, the intensity of the optical carrier wavelength component is observed.

In any case, the electric signal output from the spectrum analyzer that reflects the intensity of the optical carrier wavelength component, or the electric signal output from the photodetector is supplied to the control signal generator 32.

That is, the optical carrier wavelength component intensity detector 30 measures the intensity of the optical carrier wavelength component and generates the optical carrier intensity signal 31 reflecting the intensity of the optical carrier wavelength component. Based on the optical carrier intensity signal 31, the control signal generator 32 outputs the signals to control respectively the first polarization controller 20, the variable DGD compensator 22, and the second polarization controller 24, and according to these signals, the states of the first polarization controller 20, the variable DGD compensator 22, and the second polarization controller 24 are adjusted. In response to this, the intensity of the optical carrier wavelength component varies. Hence a feedback control system is formed where the same control is performed with the optical carrier wavelength component intensity detector 30 measuring the varying intensity of the optical carrier wavelength component.

If the optical carrier wavelength component intensity detector 30 is configured with a spectrum analyzer, the observation can be performed with not fixing but freely changing the wavelength of the optical carrier intensity signal 31. Although the purpose is to observe the intensity of the optical carrier wavelength component of the monitor signal 29, in cases where the wavelength spectrum of the monitor signal 29 has a complex structure, or the like, it may be convenient to use the scheme which observes the intensity of a wavelength component different from the optical carrier wavelength component and controls based on the observation result indirectly such that the intensity of the optical carrier wavelength component becomes minimal. In this case, the optical carrier wavelength component intensity detector 30 is preferably configured with a spectrum analyzer.

In contrast, if the optical carrier wavelength component intensity detector 30 is configured with a band pass filter and a photodetector, there is the advantage that it can be realized inexpensively, but it is difficult to separate a wavelength band having a smaller width thereby strictly limiting the wavelength band of the optical carrier intensity signal 31 as compared with where the optical carrier wavelength component is separated by a spectrum analyzer. In which one of the above forms the optical carrier wavelength component intensity detector 30 is to be configured is a matter of design to be decided on comprehensively according to the requirements or the like in the optical transmission system where the PMD suppressing apparatus of the invention is to be used.

The PMD suppressing apparatus according to the embodiment of the invention described above is configured with the first polarization controller 20, the variable DGD compensator 22, the second polarization controller 24, and the polarization beam splitter 26. However, the technical concept, associated with the PMD suppressing method according to the embodiment of the invention, of separating one of orthogonal polarization components of the output signal output from the higher-order PMD suppressing unit into a spectrum and taking out the optical carrier wavelength component as a monitor signal to use information on the intensity of the optical carrier wavelength component as a control signal for PMD suppression is not limited to the use in the PMD suppressing apparatus of this embodiment but can be implemented in optical PMD suppressing apparatuses having a configuration other than this.

In apparatuses optically implementing PMD suppression such as a PMD suppressing apparatus of the type to have the magnitude of the value of the DGD given to the input signal being fixed, a PMD suppressing apparatus configured with fiber Bragg gratings, a PMD suppressing apparatus configured with multiple stages of connected first-order PMD compensators, or the like, the technical concept of using information on the intensity of the optical carrier wavelength component as a control signal for PMD suppression can be used as means for detecting the PSP at the optical carrier wavelength and equalizing the PMD vector.

### <Numerical Computation Related to Operation Verification of PMD Suppressing Apparatus>

Numerical computation for verifying the effect of the higher-order PMD suppression by the PMD suppressing apparatus according to the embodiment of the present invention was conducted, the results of which will be described with reference to FIG. 2. FIG. 2 is a schematic block configuration diagram showing the configuration of a demonstration system for verifying the effect of the higher-order PMD suppression by the PMD suppressing apparatus according to the embodiment of the invention.

The demonstration system comprises a transmitter 50, a higher-order PMD emulator 52, the PMD suppressing apparatus 100 of the invention, and a receiver 60. The transmitter 50 outputs a CS-RZ (Carrier Suppressed Return to Zero) signal at a transmission bit rate of 160 Gbits/s. The higher-order PMD emulator 52 has the CS-RZ signal 51 from the transmitter 50 input thereto and adds higher-order PMD to the CS-RZ signal 51 to generate and output an input signal 53 to be input to the PMD suppressing apparatus 100. The receiver 60 receives an output signal 27 output from the PMD suppressing apparatus 100 of the invention. The CS-RZ signal 51 output from the transmitter 50 is a signal in which four tributary channels whose transmission bit rates are each 40 Gbits/s are time-multiplexed.

The input signal 53 output from the higher-order PMD emulator 52 corresponds to an input signal with distortion occurring in its time waveform in an actual optical transmission system and is equivalent to the input signal input to the PMD suppressing apparatus 100 of the invention described with reference to FIG. 1.

The optical carrier wavelength of the CS-RZ signal 51 output from the transmitter 50 is 1570 nm. The higher-order PMD emulator 52 comprises three PMD generators formed of a polarization controller and a variable DGD adder. That is, the emulator 52 is configured with a first combination of a first polarization controller (PC-1) and variable DGD compensator (DGD-1), a second combination of a second polarization controller (PC-2) and variable DGD compensator (DGD-2), and a third combination of a third polarization controller (PC-3) and variable DGD compensator (DGD-3). The first to third polarization controllers are of the same configuration as the first and second polarization controllers included in the PMD suppressing apparatus according to the embodiment of the invention. The first to third variable DGD adders are of the same configuration as the variable DGD compensator included in the PMD suppressing apparatus according to the embodiment of the invention.

The higher-order PMD emulator 52 adds PMD to the CS-RZ signal 51 that is a signal including no time waveform distortion due to PMD to perform the function to give time waveform distortion, which is opposite to the function to suppress the PMD of an input signal having time waveform distortion due to PMD. That is, the higher-order PMD emulator 52 is configured with three devices for adding first-order PMD connected in series, and due to the three devices for adding first-order PMD, the directions of the fast axis and the slow axis are different for each position in the optical fiber through which the signal propagates and for each wavelength component, resulting in the artificial or experimental generation of higher-order PMD.

The higher-order PMD emulator 52 generates an artificial PMD suppression-subject signal as an input signal to be input to the PMD suppressing apparatus of the invention.

The DGD-1, DGD-2, and DGD-3 were set to give DGD differences of 3.0 ps, 1.0 ps, and 1.0 ps respectively. The eigen-axis of the polarization plane of the input light to be input to the DGD-1, DGD-2, and DGD-3 is made to deviate by the PC-1, PC-2, and PC-3 respectively. The angles of the eigen-crystal axes of a quarter-wave plate (hereinafter also denoted as λ/4) and a half-wave plate (hereinafter also denoted as λ/2) forming each of the PC-1, PC-2, and PC-3 were set as follows: (λ/4, λ/2)=(22.5°, 0°), (−22.5°, −22.5°, and (5°, −22.5° respectively.

In the optical carrier wavelength component intensity detector according to the embodiment of the invention, the intensity of the optical carrier wavelength component was measured using an optical spectrum analyzer of 0.07 nm resolution.

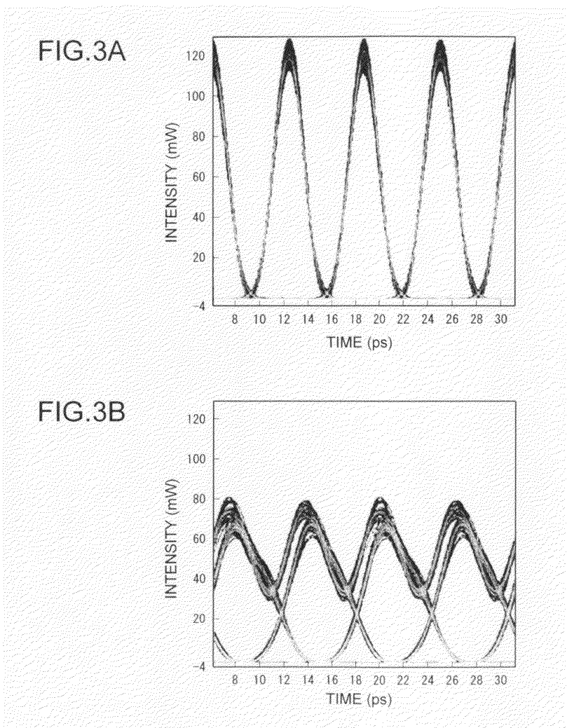

The time waveform of the CS-RZ signal 51 output from the transmitter 50 and the time waveform of the input signal 53 output from the higher-order PMD emulator 52 will be compared with reference to FIGS. 3A and 3B. FIGS. 3A and 3B show the difference between the time waveform of the CS-RZ signal without time waveform distortion due to PMD and the time waveform of a PMD suppression-subject signal (or input signal 53) with time waveform distortion caused by the higher-order PMD emulator 52 giving PMD; FIG. 3A shows the time waveform of the CS-RZ signal 51 output from the transmitter 50; and FIG. 3B shows the time waveform of the input signal 53 output from the higher-order PMD emulator 52. In FIGS. 3A and 3B, time is plotted in units of ps (picosecond) on the horizontal axis; and intensity is plotted in units of mW on the vertical axis.

The time waveforms shown in FIGS. 3A and 3B are in so-called eye-pattern display where the CS-RZ signal 51 outputs from the transmitter 50 or the input signal 53 output from the higher-order PMD emulator 52 is repetitively drawn over itself in the time width over the horizontal axis.

As apparent from comparison of FIGS. 3A and 3B, it can be seen that due to the higher-order PMD emulator 52 adding PMD, the time waveform of the CS-RZ signal 51 that was in a sine wave shape changed into the time waveform of the input signal 53 entirely different from this.

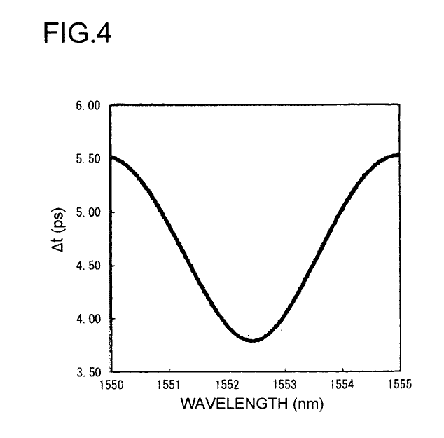

Next, the PMD given by the higher-order PMD emulator 52 being higher-order PMD will be described with reference to FIG. 4. FIG. 4 is for explaining the PMD given by the higher-order PMD emulator 52 being higher-order PMD; wavelengths are plotted in units of nm on the horizontal axis; and DGD amounts Δt are plotted in units of ps on the vertical axis.

Because the first-order PMD does not have wavelength dependency, the curve indicating DGD amounts is a straight line parallel to the horizontal axis representing the wavelength. As to second-order PMD, the DGD amount is proportional to the wavelength, and hence the curve indicating DGD amounts is a straight line non-parallel to the horizontal axis. In contrast, the wavelength dependency of the DGD amount of higher-order PMD of third or higher order is expressed as a curve as opposed to the above first-order PMD and second-order PMD. Because the wavelength dependency of the DGD amount is denoted by a curve as shown in FIG. 4, it is apparent that the PMD given by the higher-order PMD emulator 52 is the higher-order PMD.

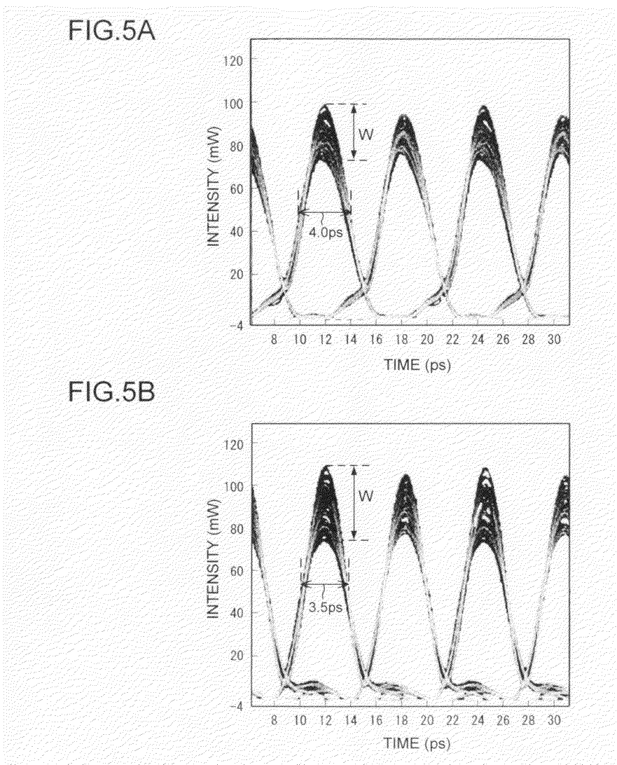

The PMD suppressing method according to the embodiment of the invention and the conventional PMD suppressing method will be compared and differences in their characteristics will be described with reference to FIGS. 5A and 5B, 6A and 6B, and 7A and 7B. In any of FIGS. 5A to 7B, time is plotted in units of ps on the horizontal axis, and signal intensity is plotted in units of mW on the vertical axis. The time waveforms shown in FIGS. 5A and 5B, 6A and 6B, and 7A and 7B are in so-called eye-pattern display where their signal is repetitively drawn over itself in the time width over the horizontal axis.

FIGS. 5A and 5B show the time waveforms of the output signals output from first-order PMD compensation units to be compared; FIG. 5A shows the time waveform of the first PMD compensated signal 23 output from the first-order PMD compensation unit of the PMD suppressing apparatus according to the embodiment of the invention; and FIG. 5B shows the time waveform of the signal output from the first-order PMD compensation unit of the conventional PMD suppressing apparatus.

The conventional PMD suppressing apparatus controls such that the DOP becomes maximal in the first-order PMD compensation unit, thereby equalizing the PMD vector which was averaged over the signal spectrum. Hence the time width of optical pulses is controlled to become smaller. That is, it can be seen that the full width at half maximum of the time waveform of one optical pulse shown in FIG. 5A is about 4.0 ps, whereas the full width at half maximum of the time waveform of one optical pulse shown in FIG. 5B is about 3.5 ps and smaller than that.

However, as to the widths of patterns (indicated by W in the figure) at the tops of optical pulses shown in FIGS. 5A and 5B, it can be seen that optical pulses shown in FIG. 5B are larger in the width than optical pulses shown in FIG. 5A. This indicates the way that waveform distortion is superimposed, which causes the higher-order PMD not to be effectively, entirely removed in the higher-order PMD suppressing unit at the subsequent stage.

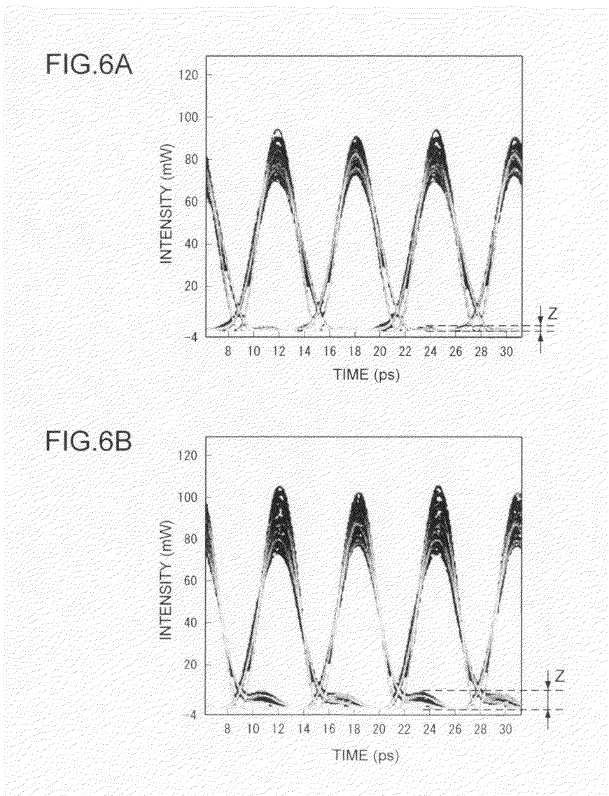

FIGS. 6A and 6B show the time waveforms of the output signals output from higher-order PMD suppressing units to be compared; FIG. 6A shows the time waveform of the second polarization plane adjusted signal 25 output from the second polarization controller of the PMD suppressing apparatus of the invention; and FIG. 6B shows the time waveform of the signal output from the higher-order PMD suppressing unit of the conventional PMD suppressing apparatus.

As shown in FIGS. 6A and 6B, the duration of optical pulses is controlled to become smaller in the conventional PMD suppressing apparatus as in FIGS. 5A and 5B, and it is common to them that the width of the pattern at the tops of optical pulses is larger.

Moreover, as shown in FIGS. 6A and 6B, the width of the tail or bottom portions (indicated by “Z” in the figure) of optical pulses is larger in the conventional PMD suppressing apparatus. These portions are called pedestal components, and if the higher-order PMD component is sufficiently small, this width is close to zero. This indicates that in the conventional PMD suppressing apparatus, waveform distortion due to the higher-order PMD is superimposed, which causes the higher-order PMD not to be effectively, entirely removed in the higher-order PMD suppressing unit at the subsequent stage.

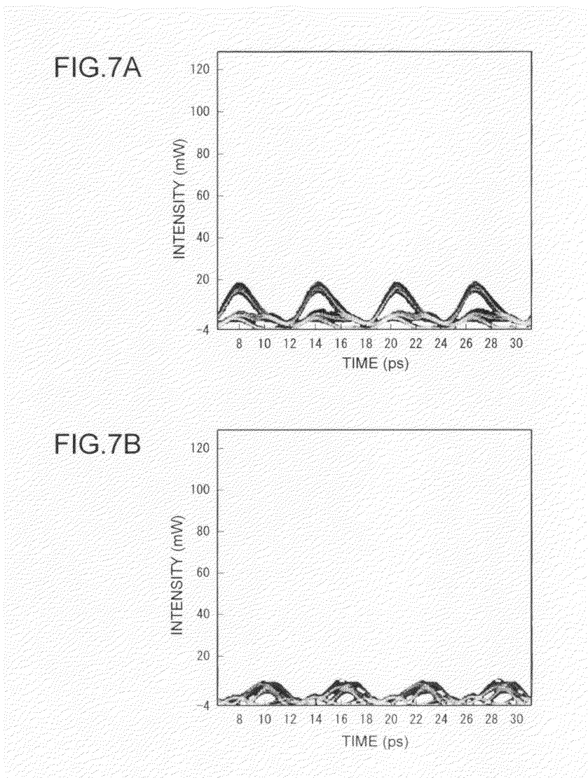

FIGS. 7A and 7B show the time waveforms of the monitor signals output from higher-order PMD suppressing units to be compared; FIG. 7A shows the time waveform of the monitor signal 29 output from the higher-order PMD suppressing unit of the PMD suppressing apparatus according to the embodiment of the invention; and FIG. 7B shows the time waveform of the monitor signal output from the higher-order PMD suppressing unit of the conventional PMD suppressing apparatus. As shown in FIGS. 7A and 7B, the two are different in waveform, which is caused by the difference that the operation principle of the conventional PMD suppressing apparatus is to use the algorithm which controls such that the DOP becomes maximal in the first-order PMD compensation unit, whereas the PMD suppressing apparatus of the invention uses the algorithm which uses the intensity of the optical carrier wavelength as a monitor signal for the higher-order PMD suppressing unit, equalizes the DGD at the optical carrier wavelength in the first-order PMD compensation unit, and removes the unpolarized component in the higher-order PMD suppressing unit.

### <Operation Verification Experiment of PMD Suppressing Apparatus>

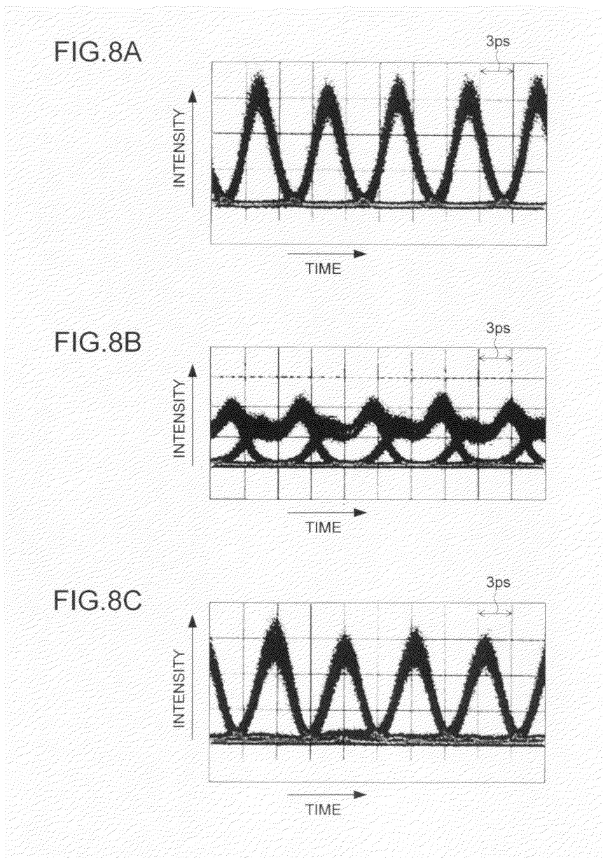

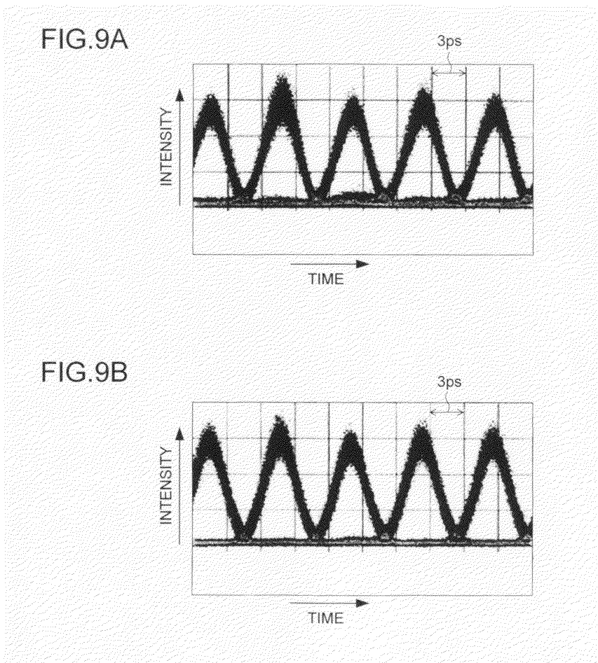

Results of further verification experiment of the effect of PMD suppression by the PMD suppressing apparatus according to the embodiment of the invention will be described with reference to FIGS. 8A to 8C and 9A and 9B. The verification experiment was conducted with varying setting parameters of the polarization controllers and variable DGD adders of the higher-order PMD emulator 52 in the demonstration system shown in FIG. 2.

The optical carrier wavelength of the CS-RZ signal 51 output from the transmitter 50 was 1550.5 nm, and the bit rate was 160 Gbits/s. The DGD-1, DGD-2, and DGD-3 were set to give time delays of 2.0 ps, 1.0 ps, and 2.0 ps respectively. The CS-RZ signal 51 output from the transmitter 50 is a signal generated by time-multiplexing four tributary channels whose bit rates are each 40 Gbits/s.

In the higher-order PMD emulator 52, the directions of the crystal axes of the λ/2 and λ/4 were varied in the range of 5° to 22.5° from the state where only the first-order PMD is generated. An optical spectrum analyzer of 0.07 nm wavelength resolution was used as means for extracting the optical carrier intensity signal 31 (see FIG. 1). For the higher-order PMD suppressed signal 27 output from the polarization beam splitter 26, the average of the Q-values of four tributary channels whose bit rates are 40 Gbits/s was calculated.

Even with such a bit error rate that in an actual optical transmission system it is difficult to detect errors in a practical measurement time, there are cases where it cannot be said that the signal-to-noise ratio (S/N ratio) of the system is sufficiently small. In this case, the Q-value described below is used to indicate the reception quality of the received optical pulse signal.

In the receivers of a transmission system using digital signals such as an optical transmission system, the received signal level is compared with a threshold level at each recognition time to determine whether or not an optical pulse exists on the time axis. For example, data for indicating the presence/absence of an optical pulse is set to “1” if an optical pulse is present, and “0” if absent. The signal level received by the receiver, that is, the intensity of the optical pulse fluctuates due to noise, and the distribution of the signal level can be represented by a probability density function.

In general, in areas where the bit error rate (BER) is low, it is difficult to detect errors in a practical measurement time, and hence the signal-to-noise ratio of the system is evaluated based on the Q-value given by the following equation:

Q (dB)=10 log{|μ₁−μ₀|/(σ₁+σ₀)}

Here μ₁ is the average of signal levels of “1” after received, μ₀ is the average of signal levels of “0” after received, σ₁ is the standard deviation of signal levels of “1” after received, and σ₀ is the standard deviation of signal levels of “0” after received.

FIGS. 8A to 8C are for explaining results of further verification experiment of the effect of PMD suppression by the PMD suppressing apparatus according to the embodiment of the invention; FIG. 8A shows the time waveform of the CS-RZ signal 51 that is the output signal of the transmitter 50 observed at the position indicated by “s” in FIG. 2; FIG. 8B shows the time waveform of the input signal 53 output from the higher-order PMD emulator 52 observed at the position indicated by “p” in the figure; and FIG. 8C shows the time waveform of the first PMD compensated signal 23 output from the variable DGD compensator 22 of the PMD suppressing apparatus 100 according to the embodiment of the invention observed at the position indicated by “q” in the figure.

In the time waveform shown in FIG. 8A, there is observed no waveform distortion, and it can be seen that the shape of the time waveform shown in FIG. 8B is greatly distorted because the higher-order PMD is added by the higher-order PMD emulator 52. In the time waveform shown in FIG. 8C, the distortion of the time waveform is compensated because the first-order PMD is compensated for, although there is variation in intensity between optical pulses.

FIGS. 9A and 9B are for explaining results of verification of the difference in the effect of higher-order PMD suppression between the PMD suppressing apparatus according to the embodiment of the invention and the conventional PMD suppressing apparatus; FIG. 9A shows the time waveform of the output signal when the higher-order PMD is suppressed by the conventional higher-order PMD suppressing method; and FIG. 9B shows the time waveform of the output signal when the higher-order PMD is suppressed by the PMD suppressing method according to the embodiment of the invention.

In the conventional higher-order PMD suppressing apparatus, the first-order PMD compensation unit uses the DOP as the monitor signal that is a reference for compensating for the first-order PMD and maximizes the DOP value, and the higher-order PMD suppressing unit minimizes the signal output from the PBS as the monitor signal that is a reference for suppressing the higher-order PMD. As to the PMD suppressed signal obtained by this conventional method, as shown in FIG. 9A, the distortion of the time waveform is compensated, although there is variation in intensity between optical pulses.

In contrast, according to the PMD suppressing method according to the embodiment of the invention, control to minimize the intensity of the optical carrier intensity signal 31 is performed via the first to third parameter signals controlling the first polarization controller 20, the variable DGD compensator 22, and the second polarization controller 24 respectively. As shown in FIG. 9B, as to the PMD suppressed signal obtained by the control method according to the embodiment of the invention, it can be seen that the distortion of the time waveform is compensated and that there is almost no variation in intensity between optical pulses.

Table 1 shows the Q-values and the DOP magnitudes of the optical pulse signals. It will be described that the higher-order PMD suppression effect of the PMD suppressing method of the invention is superior to that of the conventional method.

TABLE 1

| | Q-value (dB) | ΔQ (dB) | DOP (%) |
|---|---|---|---|
| (a) | 27.0 | 0.3 | 99.0 |
| (b) | 23.5 | 6.0 | 95.4 |
| (c) | 23.7 | 5.0 | 95.4 |
| (d) | 25.9 | 0.7 | 79.2 |

In Table 1, (a) shows results of evaluating the CS-RZ signal 51 output from the transmitter 50; (b) shows results of evaluating the first PMD compensated signal 23 generated by maximizing the DOP value; (c) shows results of evaluating the higher-order PMD suppressed signal generated through higher-order PMD suppression by the conventional method; and (d) shows results of evaluating the higher-order PMD suppressed signal 27 generated through higher-order PMD suppression by the method according to the embodiment of the invention.

In Table 1, the column on the left side labeled “Q-value (dB)” shows the average of the Q-values of four channels that are each a tributary channel; the column at the center labeled “ΔQ (dB)” shows the magnitude of the difference between the Q-values of the four channels that are each a tributary channel; and the column on the right side labeled “DOP (%)” shows the magnitude of the DOP.

By comparing values in the row labeled (c) and the row labeled (d) of Table 1, the PMD suppression effect of the conventional method and the PMD suppression effect of the method of the invention can be compared. According to the conventional method, a very high value (95.4%) was obtained for the DOP, and it can be seen that the higher-order PMD was suppressed and that the generated output signal had the unpolarized component effectively removed. However, the Q-value and variation in the Q-value between channels are large, as can be seen.

In contrast, the PMD suppressing method according to the embodiment of the invention is inferior to the conventional method in terms of removing the unpolarized component (DOP=79.2%), but the Q-value and variation in the Q-value between channels are small, as can be seen. From this, it can be seen that the higher-order PMD cannot be effectively removed by the control to maximize the DOP and that the Q-value and variation in the Q-value between channels cannot be made sufficiently small.

In optical communication systems, the magnitude of the Q-value being large and variation in the Q-value between tributary channels are important. That is, the magnitude of the Q-value being sufficiently large and variation in the Q-value between tributary channels being small are effective in reducing the bit error rate.

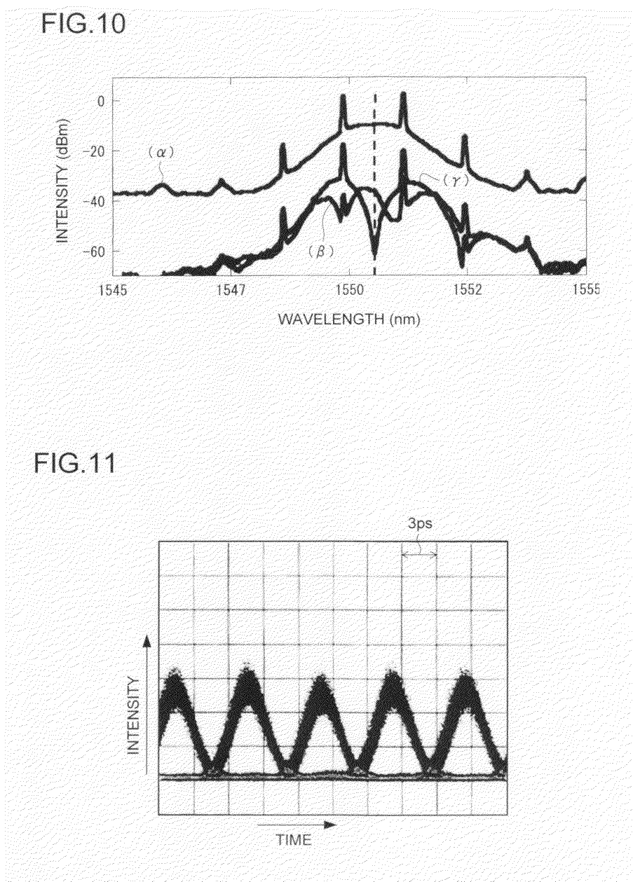

FIG. 10 shows the wavelength spectra of (a) the input signal generated by adding the higher-order PMD to the CS-RZ signal 51 output from the transmitter 50, (β) the output signal having the higher-order PMD suppressed by the conventional higher-order PMD suppressing method, and (γ) the output signal having the higher-order PMD suppressed by the PMD suppressing method according to the embodiment of the invention. Horn-like protrusions seen in each of the traces (α) to (γ) occur because the optical pulse signal is not continuous wave light but formed of a sequence of optical pulses. In FIG. 10, wavelengths are plotted in units of nm on the horizontal axis, and intensities are plotted in units of dBm on the vertical axis.

As shown in (β) of FIG. 10, in the wavelength spectrum of the output signal having the higher-order PMD suppressed by the conventional higher-order PMD suppressing method, energy around the optical carrier wavelength of 1550.5 nm remains large in value. In contrast, as shown in (γ) of FIG. 10, in the wavelength spectrum of the output signal having the higher-order PMD suppressed by the PMD suppressing method of the invention, intensities around the optical carrier wavelength of 1550.5 nm are very small, as can be seen. From this, it can be seen that with the higher-order PMD suppressing method of the invention, the optical carrier wavelength component is controlled to become minimal in intensity.

FIG. 11 shows the time waveform of the higher-order PMD suppressed signal obtained where the detector is configured with a combination of an optical band pass filter and a photodetector (not shown) to obtain the optical carrier intensity signal. Time is plotted in marks of 3 ps on the horizontal axis, and light intensity is plotted on an arbitrary scale. It can be seen that the curve representing a waveform is thicker (the eye pattern is narrower) as compared with the time waveform shown in FIG. 9B.

This is because the wavelength band of the optical carrier wave to be filtered cannot be narrowed as compared with where the optical carrier intensity signal is obtained using an optical spectrum analyzer. In connection with this, whereas the pass wavelength band width of the optical band pass filter is about 0.1 nm in half-value full width, the resolution of the optical spectrum analyzer used in the above is 0.07 nm. Optical spectrum analyzers having an excellent characteristic, i.e. a resolution of about 0.01 nm, are commercially available.

However, even with use of an optical band pass filter with which the wavelength band of the optical carrier wave to be filtered cannot be set as narrow as with an optical spectrum analyzer, the Q-value of four channels that are each a tributary channel of the generated higher-order PMD suppressed signal was 25.7 dB, and the difference between the Q-values of the four channels that are each a tributary channel was 0.2 dB, and the magnitude of the DOP was 91.2%. Even where the detector is configured with a combination of an optical band pass filter and a photodetector to obtain the optical carrier intensity signal, a high value of 25.7 dB was obtained for the Q-value of the four channels that are each a tributary channel of the higher-order PMD suppressed signal as compared with the conventional method.

From this, it was verified that according to the PMD suppressing method according to the embodiment of the invention, even with use of an inexpensively realizable apparatus configured with a combination of an optical band pass filter and a photodetector to obtain the optical carrier intensity signal, a Q-value of 25.7 dB can be obtained which is higher than the Q-value (23.7 dB) obtained with the conventional method.

The invention has been described with reference to the preferred embodiments thereof. It should be understood by those skilled in the art that a variety of alterations and modifications may be made from the embodiments described above. It is therefore contemplated that the appended claims encompass all such alterations and modifications.

This application is based on Japanese Patent Application No. 2009-046374 which is hereby incorporated by reference.

What is claimed is:

1. A polarization mode dispersion (PMD) suppressing method comprising:
a first polarization controlling step of, for a PMD suppression-subject signal inputted as an input signal, adjusting a polarization state of the input signal, thereby generating a first polarization plane adjusted signal;
a differential group delay compensation step of giving a differential group delay to one polarization mode component of an orthogonal eigen-polarization mode of said first polarization plane adjusted signal, thereby generating a first PMD compensated signal;
a second polarization controlling step of adjusting a polarization state of said first PMD compensated signal, thereby generating a second polarization plane adjusted signal;
a polarization separating step of producing and outputting a higher-order PMD suppressed signal forming one of two orthogonal components of said second polarization plane adjusted signal and a monitor signal forming the other component;
an optical carrier wavelength component intensity detecting step of measuring intensity of an optical carrier wavelength component of said input signal in said monitor signal and generating an optical carrier intensity signal reflecting the intensity of the optical carrier wavelength component; and
a control step of adjusting the polarization state of said PMD suppression-subject signal based on said optical carrier intensity signal such that the intensity of said optical carrier wavelength component becomes minimal and giving a differential group delay to the one polarization mode component of the orthogonal eigen-polarization mode of said first polarization plane adjusted signal and adjusting the polarization state of said first PMD compensated signal.

2. A polarization mode dispersion (PMD) suppressing apparatus comprising:
a first polarization controller that, for a PMD suppression-subject signal inputted as an input signal, adjusts a polarization state of the input signal, thereby generating a first polarization plane adjusted signal;
a variable differential group delay compensator that, having said first polarization plane adjusted signal inputted thereto, gives a differential group delay to one polarization mode component of an orthogonal eigen-polarization mode of the first polarization plane adjusted signal, thereby generating a first PMD compensated signal;
a second polarization controller that, having said first PMD compensated signal inputted thereto, adjusts a polarization state of the first PMD compensated signal, thereby generating a second polarization plane adjusted signal;
a polarization beam splitter that, having said second polarization plane adjusted signal inputted thereto, produces and outputs a higher-order PMD suppressed signal forming one of two orthogonal components of the second polarization plane adjusted signal and a monitor signal forming the other component;
an optical carrier wavelength component intensity detector that, having said monitor signal inputted thereto, measures intensity of an optical carrier wavelength component of said input signal included in the monitor signal and generates an optical carrier intensity signal reflecting the intensity of the optical carrier wavelength component; and
a control signal generator that, having said optical carrier intensity signal inputted thereto, generates, based on the optical carrier intensity signal, first to third parameter signals to control respectively said first polarization controller, said variable differential group delay compensator, and said second polarization controller such that the intensity of said optical carrier wavelength component becomes minimal,
wherein a PMD suppressed signal is output as an output signal from an output port at one side of said polarization beam splitter.

3. A polarization mode dispersion suppressing apparatus according to claim 2, wherein said optical carrier wavelength component intensity detector comprises a spectrum analyzer.

4. A polarization mode dispersion suppressing apparatus according to claim 2, wherein said optical carrier wavelength component intensity detector comprises a band pass filter and a photodetector.

5. A polarization mode dispersion suppressing apparatus according to claim 2, wherein said first polarization controller makes oscillation directions of orthogonal oscillating components of the input signal respectively match the fast and slow axis of said variable differential group delay compensator to adjust the polarization state of the input signal.

6. A polarization mode dispersion suppressing apparatus according to claim 2, wherein said control signal generator uses a search algorithm for performing feedback control of said first polarization controller, said variable differential group delay compensator and said second polarization controller to perform control such that the intensity of said optical carrier wavelength component included in said monitor signal becomes minimal.
